(19) United States
(12) Patent Application Publication
(10) Pub. No.: US 2006/0251356 A1
(43) Pub. Date: Nov. 9, 2006

(54) Modular, reconfigurable optical switching device

(75) Inventors: Thierry Zami, Massy (FR); Pierre Peloso, Villebon Sur Yvette (FR)

Correspondence Address: SUGHRUE MION, PLLC, 2100 PENNSYLVANIA AVENUE, N.W., SUITE 800, WASHINGTON, DC, 20037, US

(73) Assignee: Alcatel

(21) Appl. No.: 11/408,927

(22) Filed: Apr. 24, 2006

(30) Foreign Application Priority Data
Apr. 25, 2005 (FR) 0551051

(51) Int. Cl. G02B 6/26

(52) U.S. Cl. 385/17; 385/24

(57) ABSTRACT

An optical switching device comprises i) a first stage comprising N first distribution modules each having a first input coupled to an optical fiber dedicated to the transport of multiplexes of channels of different wavelengths, and n first outputs each delivering at least one of the multiplexed channels received by the first input, ii) a second stage comprising Q second selection modules each having a second input receiving at least one channel of one wavelength, and q second outputs selectively delivering one of the multiplexed channels received by the second input, with Q≧N×n, and iii) a third stage comprising a spatial switcher having, on the one hand, M third inputs and M′ third outputs, with M′≧M, at least some of the first outputs being respectively coupled to third inputs and at least some of the second inputs being respectively coupled to third outputs, and, on the other hand, coupling means designed to couple each of the third inputs to one of the third outputs according to a chosen input/output combination, which can be modifiable.

### CROSS-REFERENCE TO RELATED APPLICATIONS

This application is based on French Patent Application No. 05 51 051 filed Apr. 25, 2005, the disclosure of which is hereby incorporated by reference thereto in its entirety, and the priority of which is hereby claimed under 35 U.S.C. § 119.

### BACKGROUND OF THE INVENTION

1. Field of the Invention

The invention relates to the field of optical switching and, more particularly, reconfigurable optical switching devices designed to switch channels of wavelengths that have been multiplexed or are to be multiplexed.

2. Description of the Prior Art

The switching devices considered here are of the transparent type, that is, the channels that they switch stay constantly in the optical domain.

The abovementioned switching devices are, for example, used as input and/or output interface (or “patch panel”) in switching nodes of optical networks with wavelength division multiplexing (or (D)WDM, standing for (Dense) Wavelength Division Multiplexing).

As those skilled in the art know, when an optical switching device acts as an input interface, it receives on input ports channels of different multiplexed wavelengths (also called optical signal spectral multiplexes) that it has to switch individually (channel by channel) to respective output ports selected according to a command. Its input ports are normally coupled to optical fibers, whereas its output ports are normally coupled to input terminals of an electronic switch via an “optical-electrical” conversion interface made up of optical receivers, typically photodetectors.

Moreover, when an optical switching device acts as an output interface, it receives on input ports channels of different wavelengths that it has to multiplex and switch to respective output ports selected according to a command. Its input ports are normally coupled to output terminals of an electronic switch via an “electrical-optical” conversion interface, made up of single-wavelength optical signal transmitters, typically laser sources from which the light is modulated. Its output ports are normally coupled to respective output optical fibers.

In order for the spectral resources of an optical network to be used optimally, it is preferable for the input and/or output interfaces (patch panel) to offer a certain flexibility, or in other words, for them to be at least partially reconfigurable by a simple command and if possible without manual intervention.

To make optimal use of the available node resources, it is essential to be able to modify their allocation according to the connection requirements in the different fibers, that is, to be able to reduce the number of channels assigned to an optical fiber in which the traffic is decreasing in favor of another optical fiber in which the traffic is increasing. To achieve this objective, it is essential for at least one of the receivers initially receiving a first channel of a first optical fiber to be able subsequently to receive a second channel of a second optical fiber. When the input interface is not reconfigurable, this type of redistribution of channels between optical fibers requires a technician to physically manipulate some of its components, which takes time and can damage said components.

Since the output optical fibers normally correspond to different destinations and have to carry highly changeable traffic volumes, it is also advantageous to be able to modify, by a simple command, the numbers of channels injected into each of them.

A certain number of solutions have been proposed to make the optical switching devices (patch panels) flexible. However, although flexible, these devices are not modular. They in fact comprise a spatial switch which is initially dimensioned for a maximum network capacity, and therefore (highly) overdimensioned relative to the initial requirements. Now, given the high costs of setting up a new network, it is preferable for its operator to spread said costs over time by increasing the switching capacities of the switching devices according to requirements, which means that the switching devices must not only be reconfigurable, but also modular.

The Applicant has proposed a reconfigurable and partially modular switching device. This device, which is in particular disclosed in the French patent application filed on Sep. 17, 2004 under the number 04 52078, comprises:
a first stage having first wavelength selection modules, the inputs of which respectively constitute the input ports,
a second stage having second wavelength selection modules, the outputs of which respectively constitute output ports, and
an intermediate stage comprising star couplers for coupling the input of each second selection module of the second stage to the output of at least two first selection modules of the first stage.

The term “Wavelength Selective Switch” (WSS) is used here to mean equipment comprising, when it acts as a demultiplexer, one input and several outputs and capable of switching each (spectral) channel received on its input, selectively according to a control signal, to one of its outputs.

This equipment thus provides a programmable demultiplexing function on channels with optical frequencies that are aligned on a predetermined grid, so enabling each channel present at the input to be directed to one of the output ports according to its wavelength and a command.

This same equipment can also provide the reverse (multiplexing) function by swapping the output and input roles. In this case, it becomes equipment with several inputs and one output and can be used to switch spectral channels (that is, optical signals carried by respective wavelengths) received on respective inputs, selectively according to the wavelengths of the channels received and of the respective inputs and according to a control signal, to the output of this equipment. It is obviously preferable for the spectral channels switched to the output to have different wavelengths. The equipment then provides a programmable multiplexing function with which to supply as output a channel selected from the channels received or an output multiplex made up of a set of channels selected from the channels received.

In the description that follows, the term “selective distribution” is used to mean programmable demultiplexing and “selective distribution module” is used to mean a wavelength selection module of the WSS type with one input and n outputs.

Moreover, in the description that follows, “selective merging” is used to mean spectral multiplexing and “selective merging module” is used to mean a wavelength selection module of the WSS type with n inputs and one output. Furthermore, “non-selective merging” is used to mean the bundling of wavelengths and “non-selective merging module” is used to mean an optical coupler with n inputs and one output.

The reconfigurable switching device described above, is effectively modular inasmuch as the number of star couplers can be increased according to requirements. However, the star couplers, which are used to combine the (optical) channels originating from different optical fibers, induce certain drawbacks such as, for example, high insertion losses, which limit to relatively low values (approximately 32) the number of channels that can “circulate” in each optical fiber, and blockages when channels presenting wavelengths of the same color have to be combined by one and the same coupler.

Since no switching device is entirely satisfactory, the object of the invention is to improve the situation.

### SUMMARY OF THE INVENTION

It proposes in effect, a first optical switching device (or optical interface) comprising, firstly, a first stage provided with first inputs, that can be respectively coupled to optical fibers dedicated to transporting channels of different multiplexed wavelengths, and first outputs, secondly, a second stage provided with second inputs, that can each receive at least one channel of one wavelength, and second outputs that can each deliver a channel received on one of the second inputs, and thirdly, a third stage provided with third inputs coupled (at least for some) to first outputs and third outputs coupled (at least for some) to second inputs.

In this first optical switching device:
its first stage comprises N first distribution modules each having a first input and n first outputs that can each deliver at least one of the multiplexed channels received by the first input,
its second stage comprises Q second selection modules each having a second input and q second outputs that can each selectively deliver one of the multiplexed channels received by the second input, with Q≧N×n, and
its third stage comprises a spatial switcher having, on the one hand, M third inputs and M′ third outputs, with M′≧M, at least some of the first outputs being respectively coupled to third inputs and at least some of the second inputs being respectively coupled to third outputs, and on the other hand, coupling means capable of coupling each of the third inputs to one of the third outputs according to a chosen input/output combination.

The term “distribution modules” is used here to mean both selective distribution modules, such as wavelength selection modules, and non-selective distribution modules, such as optical couplers.

The first optical switching device according to the invention can have other characteristics which can be taken separately or in combination, and in particular:
its spatial switcher can be of modular type in order for the numbers M and M′ to be able to be adapted according to requirements defined by the total number of channels to be received on the first inputs;
the first distribution modules can be, for example, optical couplers (or “optical splitters”) with one input and n outputs or wavelength selection modules of the WSS type;
the second selection modules can be, for example, wavelength selection modules of WSS type;
its spatial switcher can include beam steering coupling means;
at least one of the first distribution modules can comprise at least one first so-called transit output. In this case, its second stage has at least one second selection module, dedicated to transit, and having a second input directly coupled to the first transit output;
the coupling means of the spatial switcher are preferably arranged to vary the chosen input/output combination according to a command.

The invention also proposes a second optical switching device (or output interface) comprising, firstly, a first stage provided with first inputs that can each receive at least one channel of one wavelength, and first outputs that can each deliver at least one channel of one wavelength, secondly, a second stage provided with second inputs and second outputs that can each deliver channels of different multiplexed wavelengths received on the second inputs, and thirdly, a third stage provided with third inputs coupled (at least for some) to first outputs and third outputs coupled (at least for some) to second inputs.

In this second optical switching device:
its first stage comprises Q first merging modules each having q first inputs and one first output,
its second stage comprises N second merging modules each having n second inputs, that can each receive at least one channel of one wavelength, and one second output, with Q≧N×n, and
its third stage comprises a spatial switcher having, on the one hand, M′ third inputs and M third outputs, with M′≧M, at least some of the first outputs being respectively coupled to third inputs and at least some of the second inputs being respectively coupled to third outputs, and on the other hand, coupling means capable of coupling each of the third outputs to one of the third inputs according to a chosen input/output combination.

The term “merging modules” is used here to mean both selective merging modules, such as wavelength selection modules, and non-selective merging modules, such as optical couplers.

The second optical switching device according to the invention can include other characteristics that can be taken separately or in combination, and in particular:
its spatial switcher can be of modular type in order for the number M to be able to be adapted according to the requirements defined by the total number of channels to be delivered on the second outputs;
the first and second merging modules can be optical couplers with n inputs and one output or wavelength selection modules of WSS type;
its spatial switcher can include beam steering coupling means;
at least one of the second merging modules can have at least one second so-called transit input. In this case, its first stage comprises at least one first merging module having a first output coupled directly to the second transit input,
the coupling means of the spatial switcher are preferably arranged to vary the chosen input/output combination according to a command.

The invention also proposes a communication node, for a (D)WDM network, comprising an electronic or all-optical switch and at least one first and/or one second optical switching device of the types of those presented above and coupled to the electronic or all-optical switch via optical/electrical conversion means or all-optical regeneration means.

### BRIEF DESCRIPTION OF THE DRAWINGS

Other features and advantages of the invention will become apparent from examining the detailed description below, and the appended drawings, in which:

FIG. 1 diagrammatically and functionally illustrates an exemplary embodiment of a first optical switching device according to the invention, of input interface type,

FIG. 2 diagrammatically and functionally illustrates a variant of the first optical switching device of FIG. 1,

FIG. 3 diagrammatically and functionally illustrates an exemplary embodiment of a second optical switching device according to the invention, of output interface type,

FIG. 4 diagrammatically and functionally illustrates a variant of the second optical switching device of FIG. 3.

### DETAILED DESCRIPTION OF THE PREFERRED EMBODIMENT

The appended drawings can be used not only to complement the invention, but also contribute to its definition, as appropriate.

The object of the invention is to allow flexibility and modularity in “patch panel” type optical (transparent) switching devices, whether used as input and/or output interface.

In the description that follows, it is assumed, by way of non-limiting example, that the optical switching devices are intended for installation in communication nodes of (Dense) Wavelength Division Multiplexing ((D)WDM) networks.

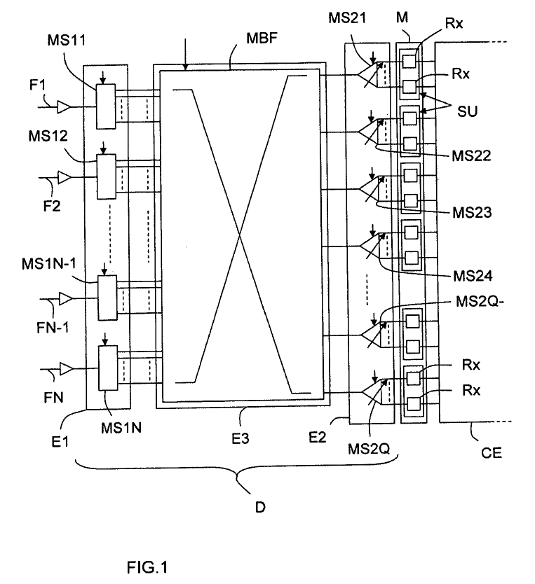

FIG. 1 diagrammatically and functionally shows an exemplary first optical switching device D, according to the invention, of input interface type.

A first device D, according to the invention, comprises first E1, second E2 and third E3 stages.

The first stage E1 comprises N first distribution modules MS1i (i=1 to N) each having one first input and n first outputs.

Each first input defines an input port of the first device D and is consequently intended to be coupled to an optical fiber (input) Fi in which “circulate” channels of different multiplexed wavelengths, also called optical signal spectral multiplexes. As illustrated, this coupling is preferably achieved via an amplifier. In the description that follows, the term optical channel is understood to mean a channel associated with a given wavelength.

For example, each optical fiber Fi is capable of transporting “c” optical channels.

The number N of first distribution modules MS1i is not necessarily fixed.

It can vary according to requirements, and in particular according to the number of input fibers Fi.

These first distribution modules MS1i are used to switch the multiplexed optical channels that they receive on their input according to their respective wavelengths to one or more of their outputs. In other words, a first distribution module MS1i provides an at least partial demultiplexing function which enables it to deliver on each of its outputs one or more (or even all) optical channels of a multiplex that it has received on its input. These are, for example, non-selective distribution modules, such as couplers (or optical splitters), or selective distribution modules, such as the wavelength selection modules of WSS (Wavelength Selective Switch) type, presented in the introduction. In the latter case, the switching of the different optical channels to the outputs (each channel received being able to be distributed only to one single output) is performed according to a specific command. The WSS modules are in particular described in the document by T. Ducellier et al., entitled “The MWS 1×4: A High Performance Wavelength Switching Building Block”, Conference ECOC'2002, Copenhagen, 9 Sep. 2002, 2.3.1. These WSS type wavelength selection modules are advantageous, particularly because they incur low insertion losses compared to those incurred by simple couplers when their number of outputs is greater than 4.

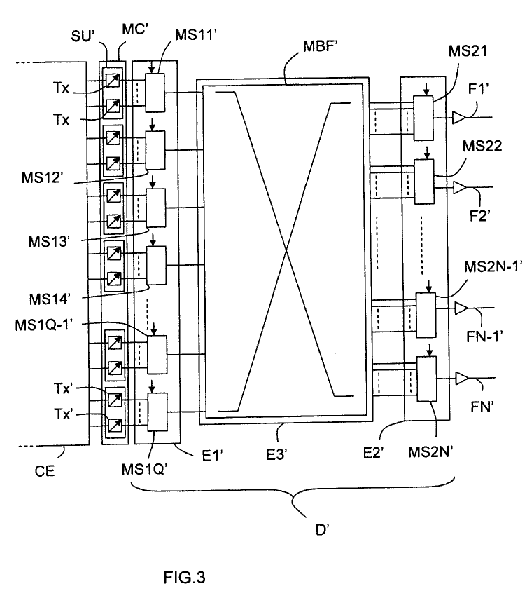

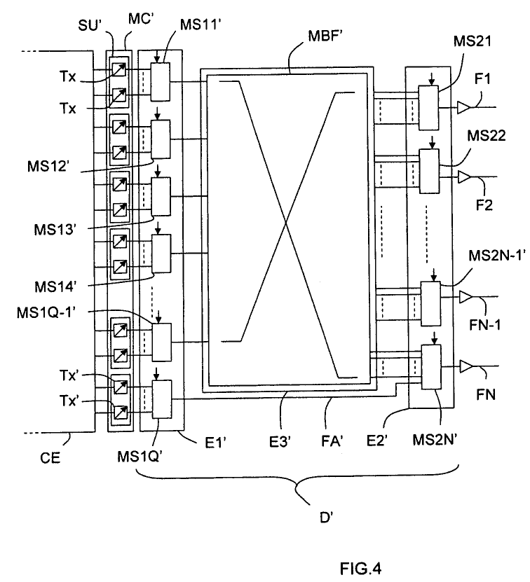

As will be seen later, with reference to FIGS. 3 and 4, the distribution modules can also provide a multiplexing function (programmable if necessary) with which to provide on their output either one optical channel selected from the optical channels of a received multiplex, or a multiplex made up of a set of optical channels selected from the optical channels received on their inputs.

It is important to note that a cascade of distribution modules can be constructed in order to increase the final number of outputs.

Moreover, it is important to note that the optical channels that are switched to a given output of a (first) distribution module MS1i must be associated with different wavelengths.

The second stage E2 comprises Q second selection modules MS2j (j=1 to Q) each having one second input and q second outputs which define the output ports of the first device D. These second selection modules MS2j (j=1 to Q) are modules of WSS type, and are therefore tunable according to a command. Each second output of a second selection module MS2j selectively delivers only one of the multiplexed optical channels received by its second input. The selection of the channels is done internally using integrated filters.

For the first device D to be able to operate at full load, Q must be greater than or equal to the product of the number N of first distribution modules MS1i and the number n of first outputs of each first distribution module MS1i, or Q≧N×n.

The number Q of second selection modules MS2j is not necessarily fixed. It can vary according to requirements and, in particular, according to the total number of optical channels transported by the different input optical fibers Fi.

As illustrated in FIG. 1, each second output of a second selection module MS2j is, for example, coupled to a receiver Rx which converts the optical signals contained in the optical channel that it receives into electrical signals. The receivers Rx are, for example, photodetectors. The q receivers Rx, coupled to the q second outputs of a second selection module MS2j, constitute, for example, a receive subunit SU. Moreover, the different receivers RX (or the different subunits SU) can be part of an optical-electrical conversion interface MC.

The output of each receiver Rx is, for example, connected to one of the input terminals of an electronic switch CE.

The third stage E3 comprises a spatial switch (similar to the stage itself) having M third inputs, M′ third outputs and coupling means MBF for coupling each of the M third inputs to one of the M′ third outputs according to a chosen input/output combination. Preferably, the coupling means MBF are arranged to vary the chosen input/output combination according to a command.

The term “input/output combination” is understood here to mean a set of couples each comprising one of the M third inputs and one of the M′ third outputs having to deliver the optical channels received by this third input.

It is important to note that the number M is less than or equal to the number M′ (M≦M′).

At least some of the first outputs of the first distribution modules MS1i are respectively coupled to third inputs, and at least some of the second inputs of the second selection modules MS2j are respectively coupled to third outputs.

It should be noted that some third inputs of the spatial switcher E3 may not be used at a given time. Similarly, some third outputs of the spatial switcher E3 may not be used at a given time. Moreover, the numbers M and M′ are not necessarily fixed. They can vary according to requirements and, in particular, according to the total number of channels received on the first inputs. Thus, on installation of the network, the spatial switcher E3 can be, for example, of 16×16 type, then it can subsequently be converted to a 32×32 or 64×64 switcher. However, this modular characteristic is not mandatory.

The coupling means MBF are, for example, of the so-called “beam steering” type. It is possible, for example, to use the modular M×M′ spatial switchers marketed by ContinuumPhotonics under the registered trademark DirectLight®, IG series. Information on these switches can be obtained from the ContinuumPhotonics Internet site at “www.continuumphotonics.com”.

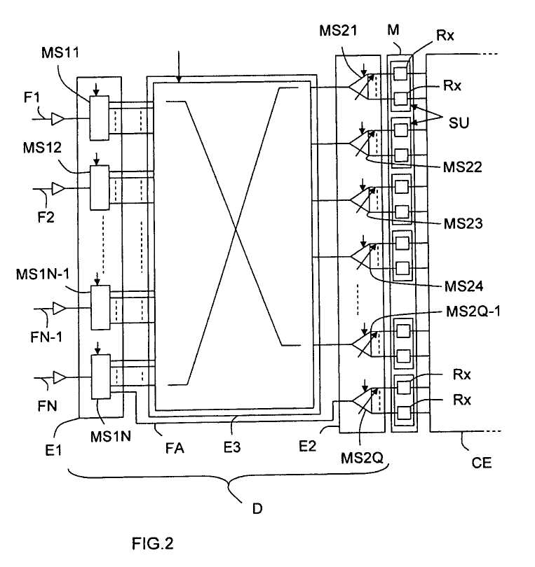

In a variant of the first device D, illustrated in FIG. 2, at least one of the first distribution modules (in this case MS1N) can include at least one first so-called transit output, intended for coupling, via an additional optical fiber FA (for example), to the second input of a second selection module (in this case MS2Q), dedicated to transit. All or only some of the optical traffic that arrives at the first distribution module MS1 N can thus be directly routed to a second selection module MS2Q, without involving the spatial switcher E3.

FIG. 3 diagrammatically and functionally represents an exemplary embodiment of a second optical switching device D′, according to the invention, of output interface type.

A second device D′, according to the invention, comprises first E1′, second E2′ and third E3′ stages.

The first stage E1′ comprises Q first merging modules MS1i′ (i=1 to Q) each having q first inputs and one first output.

Each first input defines an input port of the second device D′, intended, for example, to be coupled to a transmitter Tx of single-wavelength optical signals, itself connected to an output terminal of an electronic switch CE.

Each transmitter Tx is responsible for converting the electrical signals, that it receives from the electronic switch CE, into optical signals contained in an optical channel associated with a given wavelength. The transmitters Tx are, for example, laser sources from which the light is modulated, and which are wavelength-tunable according to a command. The q transmitters Tx, coupled to the q first outputs of a first merging module MS1i′, constitute, for example, a transmit subunit SU′. Moreover, the various transmitters Tx (or the various subunits SU′) can be part of an electrical-optical conversion interface MC′.

The number Q of first merging modules MS1i′ is not necessarily fixed. It can vary according to requirements and, in particular, as will be seen later, according to the total number of optical channels that can be transported by the output optical fibers Fi′ respectively connected to the output ports of the second device D′.

Each first merging module MS1i′ is responsible for multiplexing the optical channels that it respectively receives on its q first inputs in order to deliver a multiplex of optical channels on its first output. These are, for example, non-selective merging modules, such as optical couplers, or selective merging modules, such as wavelength selection modules of WSS (Wavelength Selective Switch) type, presented in the introduction.

The second stage E2′ comprises N second merging modules MS2j′ (j=1 to N) each having n second inputs and one second output.

Each second output defines an output port of the second device D′ and is consequently intended to be coupled to an (output) optical fiber Fi′ in which can “circulate” multiplexed optical channels. As illustrated, this coupling to an optical fiber Fi′ is preferably performed via an amplifier.

Each second merging module MS2j′ is responsible for multiplexing the or each optical channel that it receives on each of its n second inputs in order to deliver a multiplex of optical channels on its second output. These are, for example, non-selective merging modules, such as optical couplers, or selective merging modules, such as wavelength selection modules of WSS (Wavelength Selective Switch) type, presented in the introduction.

For the second device D′ to be able to operate at full load, Q must be greater than or equal to the product of the number N of second merging modules MS2j′ and the number n of second outputs of each second merging module MS2j′, or Q≧N×n.

The number N of second merging modules MS2j′ is not fixed. It preferably varies according to requirements and, in particular, according to the number of output optical fibers Fi′ used.

The third stage E3′ comprises a spatial switcher (like the stage itself) with M′ third inputs, M third outputs and coupling means MBF′ responsible for coupling each of the M third outputs to one of the M′ third inputs according to a chosen input/output combination. Preferably, the coupling means MBF′ are arranged to vary the chosen input/output combination according to a command.

The term “input/output combination” is used here to mean a set of couples each comprising one of the M′ third inputs and one of the M third outputs having to deliver the optical channels received by this third input.

It is important to note that the number M is less than or equal to the number M′ (M≦M′).

At least some of the first outputs of the first merging modules MS1i′ are respectively coupled to third inputs, and at least some of the second inputs of the second merging modules MS2j′ are respectively coupled to third outputs.

It will be noted that some third inputs and/or some third outputs of the spatial switcher E3′ may not be used at a given time. Moreover, the numbers M′ and M are not necessarily fixed. They can vary according to requirements and, in particular, according to the total number of channels that the output optical fibers Fi′ can accept. Thus, on installation of the network, the spatial switcher E3′ can be, for example, of 16×16 type, then it can subsequently be converted to a 32×32 or 64×64 switcher. However, this modular characteristic is not mandatory.

The coupling means MBF′ are, for example, of beam steering type. As in the case of the first device D, it is possible, for example, to use the modular M′×M spatial switchers made by ContinuumPhotonics and marketed under the trademark DirectLight®, IG series.

In a variant illustrated in FIG. 4 as a non-limiting example, the first output of at least one of the first merging modules (in this case MS1Q′), of the second device D′, can be directly coupled, via an additional optical fiber FA′ (for example) to one of the second inputs, then called transit, of one of the second merging modules (in this case MS2N′) of the second stage E2′. At least some of the optical traffic that arrives at the first merging module MS1Q′ can thus be directly routed to the second transit input of the second merging module MS2N′, without involving the spatial switcher E3′.

The invention makes it possible to significantly reduce the insertion losses by approximately 7 dB compared to the devices of the prior art. Consequently, it is possible either to use lower power amplifiers, for example 23 dBm with optical fibers each transporting 64 channels.

Moreover, in the case of a first device (D) using first distribution modules (MS1i) of WSS type, only the channels that must effectively be detected are present in the optical comb that arrives at the second distribution module (MS2j) responsible for separating these channels. Consequently, when N channels must be separated, only N−1 tunable filtering ports and one transit port are needed, so reducing the costs of the second stages (E2).

The invention is not limited to the embodiments of first and second switching devices and of communication node described above, purely by way of example, but it embraces all the variants that can be envisaged by those skilled in the art within the framework of the claims below.

Thus, in the above text, exemplary embodiments have been described in which the switching device was either of input interface type or of output interface type. However, because of the so-called “reverse light return” principle, it is possible to envisage the switching device being an input and output interface.

Moreover, the above text has described exemplary embodiments in which the first device or the second device was coupled to an electronic switch via opto-electronic converters. However, the invention applies equally to situations in which the first device or the second device is coupled to an optical switch via all-optical regeneration means.

1. An optical switching device, comprising i) a first stage provided with first inputs, designed to be coupled respectively to optical fibers dedicated to transporting channels of different multiplexed wavelengths, and first outputs, ii) a second stage provided with second inputs, designed each to receive at least one channel of one wavelength, and second outputs designed each to deliver a channel received on one of said second inputs, and iii) a third stage provided with third inputs coupled, at least for some, to first outputs and third outputs coupled, at least for some, to second inputs, wherein:
said first stage comprises N first distribution modules each having a first input and n first outputs each designed to deliver at least one of the multiplexed channels received by said first input,
said second stage comprises Q second selection modules each having a second input and q second outputs each designed to selectively deliver one of the multiplexed channels received by said second input, with Q≧N×n, and
said third stage comprises a spatial switcher having i) M third inputs and M′ third outputs, with M′≧M, at least some of said first outputs being respectively coupled to third inputs and at least some of the second inputs being respectively coupled to third outputs, and ii) coupling means designed to couple each of said third inputs to one of said third outputs according to a chosen input/output combination.

2. The device according to claim 1, wherein said spatial switcher is of modular type, such that said number M can be adapted according to the total number of channels to be received on said first inputs.

3. The device according to claim 1, wherein said first distribution modules are chosen from a group having at least the optical couplers with one input and n outputs and the wavelength selection modules of the so-called “WSS” type.

4. The device according to claim 1, wherein said second selection modules are wavelength selection modules of the so-called “WSS” type.

5. The device according to claim 1, wherein said spatial switcher has beam steering coupling means.

6. The device according to claim 1, wherein at least one of said first distribution modules has at least one so-called transit first output, and said second stage has at

7. The device according to claim 1, wherein said coupling means of the spatial switcher are arranged to vary the chosen input/output combination according to a command.

8. An optical switching device, comprising i) a first stage provided with first inputs, designed each to receive at least one channel of one wavelength, and first outputs, designed each to deliver at least one channel of one wavelength, ii) a second stage provided with second inputs and second outputs designed each to deliver channels of different multiplexed wavelengths received on said second inputs, and iii) a third stage provided with third inputs coupled, at least for some, to first outputs, and third outputs coupled, at least for some, to second inputs, wherein:
said first stage comprises Q first merging modules each having q first inputs and one first output,
said second stage comprises N second merging modules each having n second inputs, designed each to receive at least one channel of one wavelength, and one second output, with Q≧N×n, and
said third stage comprises a spatial switcher having i) M′ third inputs and M third outputs, with M′≧M, at least some of said first outputs being respectively coupled to third inputs and at least some of said second inputs being respectively coupled to third outputs, and ii) coupling means designed to couple each of said third outputs to one of said third inputs according to a chosen input/output combination.

9. The device according to claim 8, wherein said spatial switcher is of modular type, such that said number M can be adapted according to the total number of channels to be delivered on said second outputs.

10. The device according to claim 8, wherein said first and second merging modules are chosen from a group comprising at least the optical couplers with n inputs and one output and the wavelength selection modules of the so-called “WSS” type.

11. The device according to claim 8, wherein said spatial switcher has beam steering coupling means.

12. The device according to claim 8, wherein at least one of said second merging modules has at least one second so-called transit input, and said first stage comprises at least one first selection module having a first output coupled directly to said second transit input.

13. The device according to claim 8, wherein said coupling means of the spatial switcher are arranged to vary the chosen input/output combination according to a command.

14. A communication node for an optical network with wavelength division multiplexing, which comprises an electronic switch and at least one optical switching device according to claim 1, coupled to said electronic switch via optical/electrical conversion means.

15. A communication node for an optical network with wavelength division multiplexing, which comprises an optical switch and at least one optical switching device according to claim 1, coupled to said optical switch via all-optical regeneration means.
